(19) United States
(12) Patent Application Publication
(10) Pub. No.: US 2010/0161443 A1
(43) Pub. Date: Jun. 24, 2010

(54) PURCHASES USING UNIQUE CODES

(75) Inventors: Howard Ganz, North York (CA); Karl Joseph Borst, Toronto (CA)

Correspondence Address: Pearne & Gordon LLP, 1801 East 9th Street, Suite 1200, Cleveland, OH, 44114-3108, US

(73) Assignee: GANZ, an Ontario partnership consisting of 2121200 Ontario Inc. and 2121812 Ontario Inc., Woodbridge (CA)

(21) Appl. No.: 12/466,515

(22) Filed: May 15, 2009

Related U.S. Application Data
(60) Provisional application No. 61/140,267, filed on Dec. 23, 2008.

(51) Int. Cl. G06Q 30/00; G06Q 20/00; G06F 15/16; G06Q 10/00

(52) U.S. Cl. 705/26; 705/39; 709/204; 705/30

(57) ABSTRACT

An E-store allows purchase of codes for use on another website. The codes can be redeemed for items or credit on a website different from the site on which they were purchased. This allows obtaining items on the website without requiring real money or virtual money to be paid for the items. In addition, credits can be awarded using an administrative tool that distributes the credits or a portion thereof based on automatically detected events.

This application claims priority from Provisional application No. 61/140,267, filed Dec. 23, 2008, the entire contents of which are herewith incorporated by reference.

### BACKGROUND

The system described in our U.S. Pat. No. 7,425,169, the entire contents of which are herewith incorporated by reference, describes an online system where the user can log into a computer, and store information indicative of multiple different avatars within that computer. For example, in our patent, users purchase tangible items, e.g., toys or other figurines. Each purchased item is associated with a unique code.

A computer system accepts the unique code and retrieves a pre-stored profile indicative of the item that was pre-associated with that unique code. Therefore, the user gets both a tangible item and an online persona that has at least one characteristic that is similar to the tangible item. The user can then interact with the online persona via a website.

The user can also carry out various activities on the website to earn points, and then can use the points to buy various items that are usable on the website.

### SUMMARY

The present application describes purchasing items for use on a website and obtaining unique codes that can be redeemed to obtain the purchased items. The code allows any user of the website to obtain an item on the website. The code can be used by anyone including, for example, the person who purchased the item on the website or anyone else. This produces an entirely new paradigm allowing anyone to purchase an item for use on a website for some other person. Moreover, the particulars of that other person's account need not be known to the user purchasing the item.

Another aspect described herein describes using these special codes as part of a customizable gift card.

Yet another code describes using a first code to purchase a second special code where the first code represents a first “reward” which can be points, or items on the website or virtual cash, and the second code represents a second reward different than the first reward.

### BRIEF DESCRIPTION OF THE DRAWINGS

These and other aspects will be described in detail with respect to the accompanying drawings, wherein:

FIG. 1 shows a block diagram of the overall system;

FIG. 2 shows a flowchart of operation;

FIG. 3 shows an interface from which items can be selected;

FIG. 4 shows a particular animated item that can be obtained;

FIG. 5 shows a user interface and close-up of the item;

FIG. 6 shows an interface and template for forming the code into a gift card format; and

FIG. 7 shows an embodiment of a deluxe membership with administrative tools.

### DETAILED DESCRIPTION

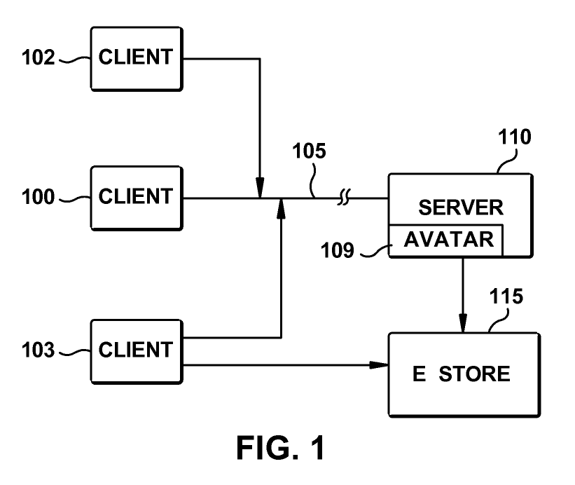

An embodiment is shown in FIG. 1, in which a client computer 100 connects over a network, e.g., the Internet 105 to a remotely located server 110. Other clients including 102 and 103 are also shown connected to the Internet, and in general any number of clients can connect to the server 110. The server 110 may be a site that hosts an application or website 109, where users can interact with avatars that they have registered on the website 109, called herein “the avatar site”, hosted by the server 110. The avatars can interact and/or coexist with other items, such as virtual rooms, furnishings, furniture, etc. These other items can be supplied for free by the avatar website, earned on the avatar website, or purchased on the avatar website or on another site, called a “purchasing site” 115. Similarly, the tangible characters themselves may be purchased, e.g., in a brick and mortar store. U.S. Pat. No. 7,425,169, having a common assignee to the present application, has a description of how tangible items are purchased which include a unique code that is used on the website and produces an avatar that resembles the purchased tangible item.

The purchasing site 115 is referred to in this embodiment as the “E store”. This E store 115 may be on the same server 110 or on a different server. The clients such as 103 can also connect to the site 115. Each of the operations and functions carried out herein can be carried out on a computer that is programmed according to these functions.

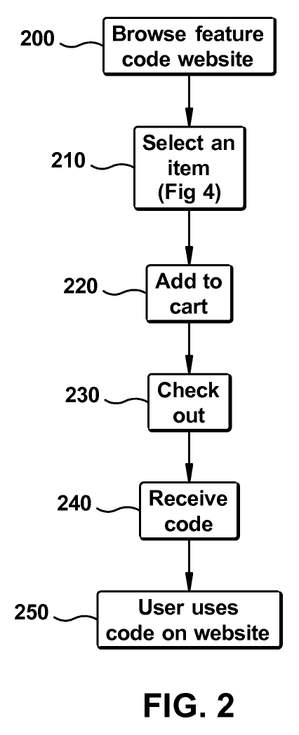

In operation, the client browsers can purchase items on the E store website 115. Referring to FIG. 2 at 200, the system identifies items to be purchased. In one embodiment, each item that can be purchased may be for exclusive use on the avatar site 109. In another embodiment, the items for sale on the E store website 115 may be for use on a number of different websites in addition to the avatar website 109. These products can later be sold on the site; for example, a user might be able to sell furniture, items, and the like, on the site. Income earned from selling such items may be increased by selling items or objects on the site that cannot be “earned” on the site but that can only be purchased. Items that can only be purchased (or only purchased on any specific website) are called “exclusive” items.

The items available to be earned or purchased using virtual cash on the avatar website 109 may be the same items that are available for purchase on the E store website 115, or may be exclusive items that can only be obtained on the E store website 115.

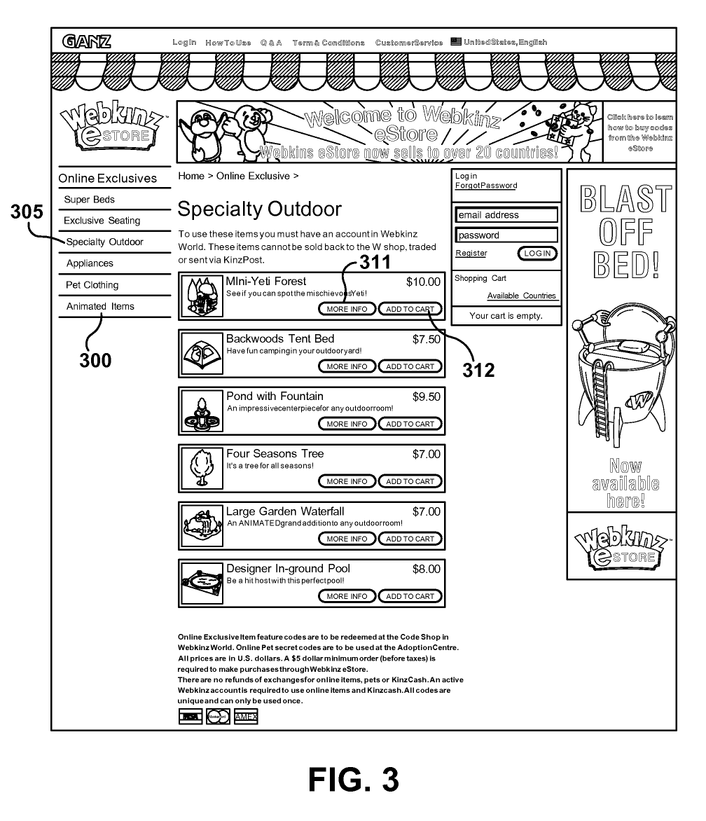

FIG. 3 illustrates an exemplary interface which may be used to purchase these items. Menu 300 represents the different categories of items which can be selected for purchase and viewing. For example, this may include online exclusive items, which are items that can only be obtained on the E store website 115, or other items that can be obtained on the website by making purchases using real, not virtual, money.

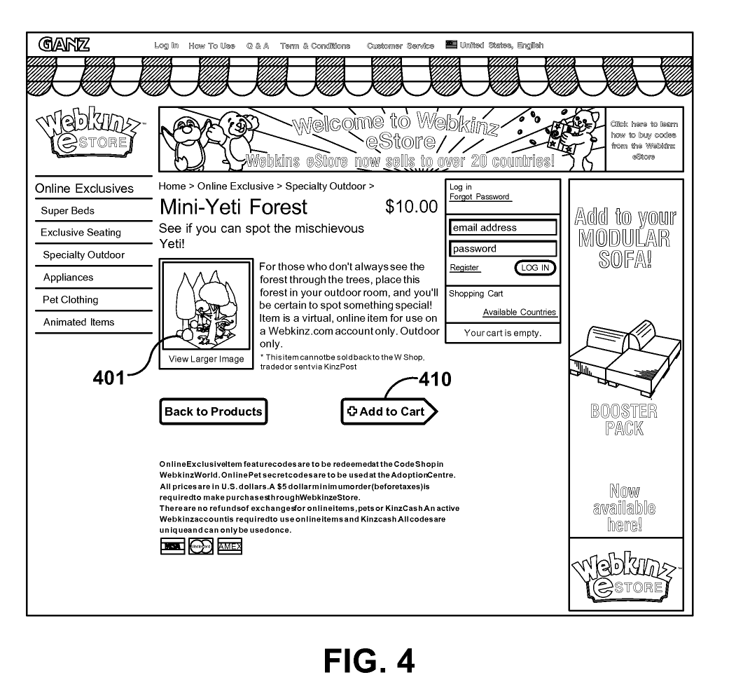

In this embodiment, the “Specialty Outdoor” category 305 has been selected, providing a list of the different specialty outdoor items that can be purchased. For any of these items, such as the “Mini-Yeti Forest”, the user can select the “More Info” indication 311, or select to purchase the item thereby adding it to their cart at 312. Selecting the “More Info” button 311 provides more information about the item. For example, by selecting button 311, one receives the screen shown in FIG. 4 which includes more information about the specific item. Here, the specific item is the “Mini-Yeti Forest”. This Mini-Yeti Forest is a virtual online item that allows playing a game where you try to spot the “Yeti” within the forest.

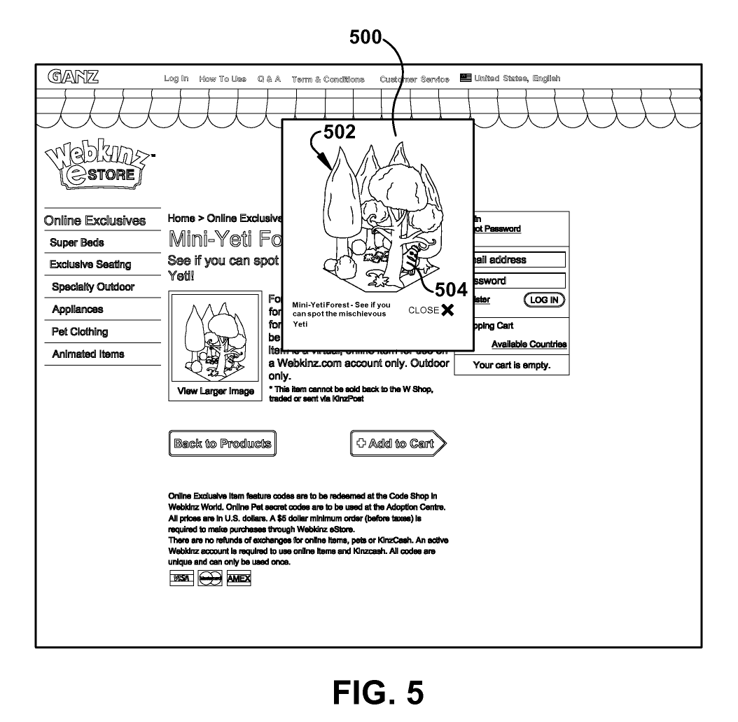

When selecting the item, users are also given the option to control selection of a larger image of the item. This selection brings up a detailed screen such as shown in FIG. 5, showing most of the background of the previous screen (FIG. 4) darkened out or reduced in brightness, and showing a close-up view 500 of the item itself. Note that the item includes a number of trees such as 502 which form a forest and an item, here a “Yeti” 504, that moves within the forest. The user can also play a game with that item, such as by finding the Yeti by clicking on the Yeti or by performing some similar action. Prizes may be awarded for high scores, for example. This animated item as purchased forms an animated item that can be placed within any outdoor room.

Returning to FIG. 4, other than viewing the larger image at 401, the user can also add this item to their cart at 410. Adding the item to the cart causes the purchase price, here $10, to be added to the cart, and the user is then allowed to purchase the item through a checkout process.

Different items can be purchased in this way. In addition to the “Specialty Outdoor” items shown in FIG. 3, beds, for instance, can also be purchased. The beds are items that the user can use to allow their pet to sleep in. In addition to beds, seats can also be purchased to allow seating for one or more different pets. Some of these seats may be removable or expandable. The site further allows purchasing appliances, where the user can use these appliances within their virtual room. It allows purchasing pet clothing, such as shirts or other items, or a suit of armor. It also allows purchasing animated items, where the Mini-Yeti Forest described above is one such example of an animated item. Other examples of animated items are waterfalls, and the like, that remain animated whenever viewed. Like the Mini-Yeti Forest, the items can also be interactive, e.g., the item itself can allow games to be played within the item.

After selecting an item at 210, and receiving the screen of FIG. 4, the user is allowed to add that item to their cart at 220. Checkout is carried out at 230, where the user on the website uses real money, e.g. a credit card, to pay the real cash amount for the item. After checking out, at 240, the user receives a unique code which can be used only once by any person. That unique code, received at 240, can be used on the avatar site at 250 in order to receive the item purchased.

Other systems may provide the actual item, e.g., into the user's account. The present system provides codes that can be used to get the purchased item.

An important advantage is that an embodiment allows a children's site to obtain an extra source of revenue, while keeping the site appropriate for children. This allows items to be purchased, without requiring people, especially children, to directly participate in or perform transactions involving real money in order to buy items on the site. In this embodiment, another user purchases codes with real money, thereby allowing the user on the website to use those codes without spending real money.

Conventional systems operate with credits. Users may purchase credits for another user and deposit those credits directly into another user's account. The credits could then be used by the “other” user to purchase things on the website.

However, the current inventors recognize a number of problems with such conventional systems. First of all, a credit style system requires that the user purchasing the credits have information about the other user's account. For example, a purchaser cannot provide credits to someone else's account without having that person's account information. This makes it more difficult to surprise someone by giving them a gift of the item, since the purchaser has to ask the recipient for their account information.

The present embodiment allows purchasing items that are wholly separate and independent of the account to which they are being added. Anyone can buy a code, for example, for the Mini-Yeti Forest. A purchaser can use the code to get the Yeti Forest for himself or can give it to a second person to use it.

In addition, the inventors noticed that when giving someone credits, that gift is akin to giving a person money for their birthday, which is a not a personal gift. An embodiment allows getting a code indicative of a gift, making that gift more personal than cash or credits—and that code can be given to any person. One unexpected advantage is that the code can be provided to the recipient without telling the recipient what the code represents. There is a special surprise in allowing the person to use the code to receive a gift. Anybody can buy the code and give the code to someone else; however, the code can be used only once, for example.

Once the code is registered on the website (FIG. 2 at 250), that code causes them to obtain the item. The user who receives the code does not need to know what the code represents.

The E store is meant for adults since real money transactions are performed when purchasing items. The website can be compliant with the Children's Online Privacy Protection Act (COPPA). The children only get a code to use on the website. This produces the unexpected results that children obtain only a code that represents an item, rather than obtaining credits that need to be handled and monitored in an analogous way to cash. The code does not require its recipient to use any discretion in spending its contents as is typically required when spending cash, credit, or some other form of currency.

In addition to the types of items discussed above, other types of items can be purchased on the website. For example, the website can allow purchasing avatars, and using the avatar wholly virtually. The codes can be also be redeemed for tangible items, e.g., items that are mailed to the user.

Another advantage of this system is that the code can then be used as part of a special kind of gift card. Conventional gift cards have a code which can be turned into use as an amount of credit. For example, gift cards from brick and mortar stores may have a bar code that is scanned to obtain information on the amount of available credit on the card. According to the present system, a special code is provided as part of the purchase. That code may be provided on an electronic representation of a paper card. The card can be customized and created to use as part of a gift giving process.

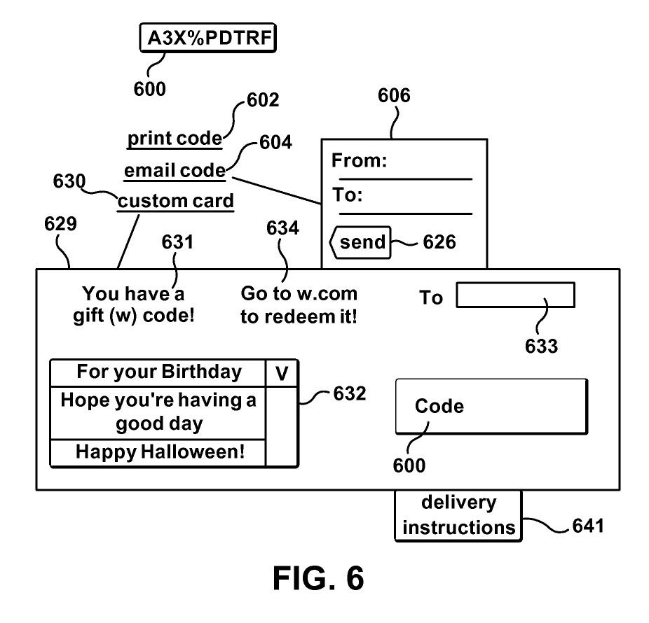

For example, after receiving the code at 240, the user may be presented with a number of different options. A code customization may be carried out. The code may be provided in the section 600 as shown in FIG. 6. The user is then given a number of different options such as to print 602 the code, in which case the page including the code is printed, or to e-mail 604 the code, which when selected may bring up the ability to e-mail the code to an e-mail address. The “email” option may bring up a page 606 that provides the destination e-mail address, and requires entry of the sender's email address. When clicking the “send” button 626, an e-mail is sent with the code 600, and a message that the code has been sent from the e-mail address.

As mentioned above, the gift cards can also be customized using a “Custom Card” option 630. The “Custom Card” option 630 brings up the ability to create a customized card. 630 brings up a card creator program, which may be a widget including various sections and options. 629 illustrates a screen which shows the card and its areas that can be customized by the sender.

A pull-down menu 632 may have a list of different occasions for which the gift might be given.

A text box 633 allows typing in the person's name who will receive the code. For example, the user can type in text at 633. The card also has text such as 631 which indicates to the recipient that they have been given a “W Code” and indicates the code information that allows the code to be redeemed.

The fields on the card, e.g., “From Address” 633 and the code, can be automatically populated or can be entered by the user. Automatically populated fields can be obtained from the billing information, for example.

The card may also include “Instructions” 634 that explain to the user how to use the code on the website. The code 600 itself is also shown on the card.

The card can be printed and sent on paper, or can be sent by email. Delivery instructions 641 can be used to control the sending, using a similar format, for example, to the box 606.

The card that is made can be created as an image, for example. However, the code can be text-based even when the remainder of the card is image-based, so that the user can cut and paste the code to use it on the website, in one embodiment. In another embodiment, clicking on an area of the code 600 opens a webpage or other window with a text version of the code.

Another embodiment allows the code itself to represent another code. For example, the user can use the code to obtain another code. In one embodiment, for example, a code may be redeemed to obtain credit for use on the website. That credit is then used on the website to buy another code that represents an item. For example, the user may be given a code that is worth $10 of credit of virtual money on the website. The user can then use that code to buy a Mini-Yeti Forest on the website. Once having purchased the Mini-Yeti Forest, the user receives a code that can be used on the W site to obtain the Mini-Yeti Forest.

As described above, an unexpected result is that this avoids a child having to manage a cash-like commodity and make purchases. If a person is giving a gift to a child, the gift can be given as an actual item usable to purchase things on the website.

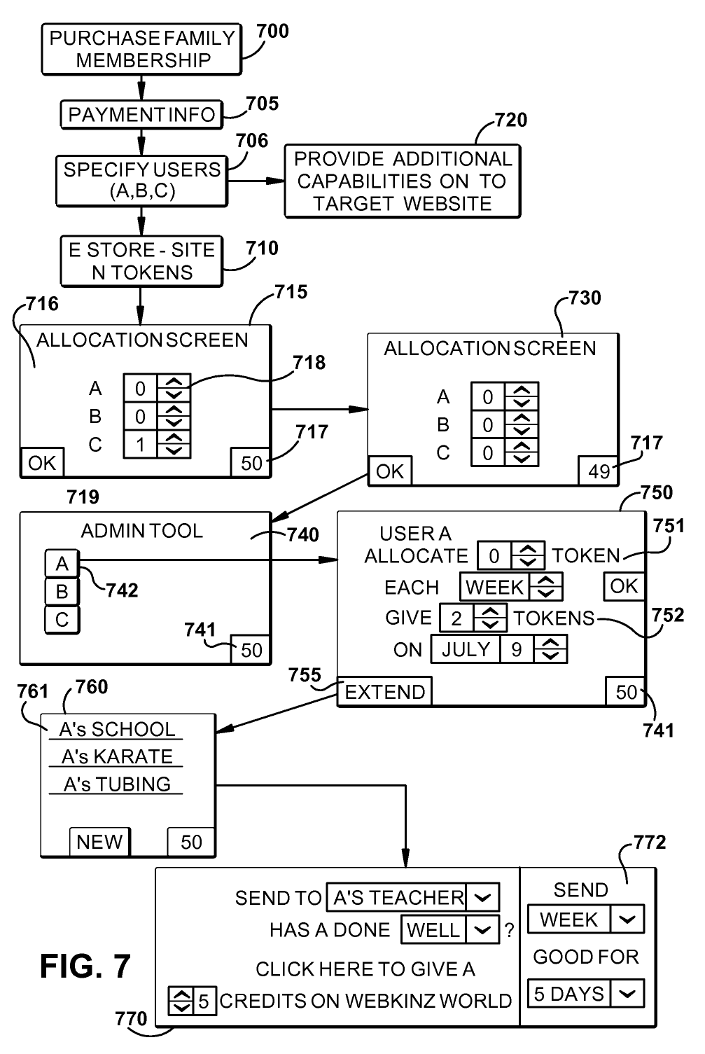

According to another embodiment, the E store operation for any of the herein-described embodiments is modified to provide a deluxe membership which has multiple upgraded capabilities on the website. FIG. 7 illustrates the deluxe membership embodiment. At 700, the site provides the ability to purchase a deluxe membership. The deluxe membership option may provide additional items for use both on the E store and on the site that is associated with the E store.

Responsive to selecting a deluxe membership for purchase at 700, the user enters payment information at 705, and once verified, the user gets two different items that are usable on different parts of the website.

At 706, the user who purchased the deluxe membership specifies user names of the special (e.g., family) members associated with their account. The user names are shown herein as A, B, and C. Those users get the special member benefits as described herein.

At 710, responsive to purchasing the deluxe membership, the user who purchased the deluxe membership, called herein the “supervisory user”, obtains credits. The credits are units of virtual currency for use on the website, for example, 10 credits may be used to purchase some virtual or real item from the website. The credits can also be sent to others as described herein. The supervisory user receives N credits (in this embodiment, 50 credits) for use on the E store. These credits may be used in any way or in any of the techniques disclosed in the previous embodiments.

The specified users, e.g., A, B and C, receive additional capabilities on the website that are associated with the E store. The additional capabilities 720 can be carried out by the specified users in parallel, for example at the same time, or at different times. In this embodiment, the website is one or more target websites on which the E store credits can be used. For example, E store credits can be redeemed to buy things on the website. In particular, E store credits can be used to purchase codes which correspond to items (e.g., Mini-Yeti Forest). As in the previously discussed embodiments, a “code” can be provided to the website user, and that code is redeemable for either the items selected by the credits or for credits based on the number of credits redeemed.

At 720, the specified user obtains additional capabilities on one or more target websites as well as receiving a designated number of E store credits.

The additional capabilities may include additional activities that can be carried out on the one or more target websites as well as additional times that the activities can be carried out. For example, on the Webkinz® site, a user may have the ability to spin the “Wheel of WOW” a certain number of times, for example two times in a 24 hour period.

After purchasing the deluxe membership, however, all of the specified users associated with that deluxe membership, may receive 4 spins on the Wheel of Wow during each day period. More generally, the additional capabilities of 720 may be usable in conjunction with an activity that is limited on the website.

According to an embodiment, the deluxe membership gives a number of credits that represent a bonus the user could get by purchasing credits directly with a payment. For example, by paying $30 for membership, the supervisory user might get $50 worth of credits. In another embodiment, the user paying $30 gets $30 in credits.

After receiving the N credits at 710, the supervisory user is provided with an interface 715 that allows and controls allocating these credits. The specified users A, B and C, which were registered at 706, are shown. The supervisory user is provided with the ability to distribute credits, which are converted to credits upon transfer, to each specified user's account. For example, the credits are shown in 715 where the supervisory user has 50 credits available. User A 716 is shown with zero. This does not mean that the user has 0 credits total, but rather means that the user A has been allocated 0 credits from the available number of credits at 717.

The supervisory user can use the arrow keys such as 718 to increase the number of credits to be transferred as credits to another, allowing the user to provide any credits from their stored credit 717 to any of the specified users A, B. and C. After executing 717 by pressing the “OK” key 719, the user is allocated with those credits.

The other users who can receive credits from the supervisory user are linked to a user interface capability available to the supervisory user. Hence, the supervisory user can allocate credits without logging in as the other users or entering their usernames etc.

According to another embodiment, the supervisory user has control over the credits even after they have been allocated. For example, the supervisory user may give 10 credits to each of A, B and C. The next day, for example, the supervisory user can remove 5 of those credits from A, and move 5 other credits from B's account to C's account.

This embodiment shows allocating individual credits, but the tool can also allocate items to the users A, B and C, where the items can be selected from a drop down list.

730 shows the result of executing the step at 715. Now the user has 49 credits in field 717, and again shows the ability to provide credits to any of the specified users A, B and C.

Since one credit has been provided to user C by the step 715, user C has been given a credit, and can use that however they want. The credit (or in the alternative embodiment, an item selected for that credit) can be sent to the user as a code that is usable on the website.

As part of the deluxe membership, the user may be charged some amount periodically such as a monthly fee. Correspondingly, the number of credits available for distribution may be increased periodically. The supervisory user, who may be for example the parent, may therefore be allowed to distribute or redistribute the unused credits among the specified users or even remove some portion of unused credits from one or more of the specified users as they feel appropriate.

Another embodiment, illustrated at 740, provides an administrative tool that allows the supervisory user to allocate credits in the future.

The available credits to be allocated may be shown in the dock area 741, representing the total number of credits that the parent has for distribution. For each of the members on the account, selecting a member provides a special tool that allows allocating the credits in the future.

Here, at 740, user A has been selected at 742, bringing up a special screen for user A that allows setting conditions for distributing the credits. The instructions define automatically distributing those credits when those conditions are met.

The items to be allocated in the future are selected as one of a temporal feature 751 and a date certain feature 752. The temporal features allow credits to be automatically allocated at specified intervals, e.g., as weekly allowances, for example. For example, user A may get a weekly allowance that includes an amount of credits, for example, one credit per week. The number and the interval of receiving the number of credits can be changed. The date certain feature 752 awards credits on a specific date, e.g., a birthday or some other date.

In another embodiment, the user can select the “external” option 755 that provides the ability to allocate credits that are tied to an external parameter. For example, this function can link to an external site or external action, and allocate the credits based on that external site or action.

A list of linked external sites is shown as 760. This list may have links to external sites corresponding to A's school (e.g., specific teachers in A's school), A's karate class, A's tutoring class, or other sites. Each individual link, such as 761, allows someone at the linked-to operation, to designate when A gets credits by indicating when A has done some action that entitles him to credits.

For example, when the link is to A's school at 761, clicking on that link may send an e-mail to A's teacher, saying

“Has A performed [x] (where x is a fill-in or selected from a pull down list). If yes, click here to give A five credits on the Webkinz® website. This is valid until [date].”

These e-mails are sent automatically to the designated external sites in order to reward one or more specified users of a deluxe membership for completing various activities.

In addition, a periodic tool 772 allows these e-mails to be sent once, weekly, monthly, on the 10th of every month, or the like.

The e-mails can have an expiration date, e.g., they expire after five days. That is, the link in the e-mails is active for only those five days (or whatever value is set). A new email can be sent, but this puts an outer limit on the award setting.

The supervisory user can fill in the various contacts to set different external characteristics that determine conditions under which A, B and C can earn credits or varying amounts of credits. If A does well in school, the teacher can reward A by clicking on the link in the e-mail. Similarly, any other actions in A's life can be rewarded in this way.

These credits can be used on the website as described above in the embodiments of FIGS. 1-6 or may be used in some other way to encourage and/or motivate positive behavior.

Another embodiment may involve automatically linking the credit distribution associated with a deluxe membership to other (external) websites without requiring e-mails to be sent. In this embodiment, the linked-to website runs an applet that allows determining this information without sending an email. This embodiment also allows setting the credits to be allocated based on an evaluation by someone outside the website.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other sites and rewards can be used. Other customizations are possible.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation, running any program.

The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

What is claimed is:

1. A method, comprising:
on a first website, using a computer for showing a number of items for sale on the first website, where said items include items which can be used on a second website which hosts a virtual world, wherein said items are usable on said second website;
using the computer for detecting a selection of an item by a user and for detecting a payment by the user for said item; and
responsive to said payment for said item, using the computer for creating information that provides a code, where said code is usable to obtain said item on the second website without providing the item itself on the first website.

2. A method as in claim 1, wherein said payment is payment in real currency.

3. A method as in claim 1, wherein said payment is payment in credits that are specific for said first website.

4. A method as in claim 1, wherein said item is an item that can be used on the second website, but is not available for acquisition on the second website.

5. A method as in claim 1, wherein said displaying a code comprises providing the user with options of a number of different ways to memorialize the code.

6. A method as in claim 5, wherein said displaying a code comprises providing the code on a virtual gift card provided to the user.

7. A method as in claim 6, wherein said gift card includes a message in addition to the code.

8. A method as in claim 7, further comprising providing a template that allows the user to customize the gift card, including at least allowing the user to select a number of different occasions for the gift card, and to add another person's name on the gift card.

9. A method as in claim 1, further comprising using the code on the second website, to obtain the item on the second website without payment by the user on the second website.

10. A method as in claim 1, wherein said displaying a code comprises providing a gift giving template that allows the user to provide an E-card that has the code attached.

11. A method as in claim 1, wherein said items are only usable on the second website.

12. A method as in claim 1, further comprising using said code on said second website to obtain said item.

13. A method as in claim 1, further comprising providing a tool on the computer that controls the user selection.

14. A method as in claim 13, wherein said tool provides criteria for selection of an item in the future.

15. A method as in claim 14, wherein said tool selects a future fixed time on which said code for said item will be provided.

16. A method as in claim 14, wherein said tool selects a condition which must be met before said code for said item will be provided.

17. A method, comprising:
using a computer for selling credits on a first website, said credits being usable to purchase items on a second website different than the first website;
responsive to obtaining payment by a user for said credits, displaying a code which represents said credits, wherein said code is different than said credits, and where said code is usable to obtain said item on the second website without providing the item itself on the first website.

18. A method as in claim 17, further comprising redeeming said code on said second website to obtain said credits on said second website.

19. A method as in claim 17, wherein said credit is usable for items that are usable on the second website.

20. A method as in claim 17, wherein said credit is usable on the second website to purchase another credit item on the second website to obtain a code for said other item on the second website.

21. A method as in claim 17, wherein said displaying a code comprises providing options of a number of different ways to memorialize the code.

22. A method as in claim 21, wherein said displaying a code comprises providing the code on a virtual gift card provided to the user.

23. A method as in claim 22, wherein said gift card includes a message in addition to the code.

24. A method as in claim 23, further comprising displaying a template that allows the user to customize the gift card, including at least allowing the user to select a number of different occasions for the gift card, and to add another person's name on the gift card.

25. A method as in claim 17, further comprising using the code on the second website, to obtain an item on the second website without payment by the user on the second website.

26. A method as in claim 17, wherein said displaying a code comprises providing a gift giving template that allows the user to provide an E-card that includes the code.

27. A method as in claim 17, further comprising providing a tool on the computer that controls the user selection of credits.

28. A method as in claim 27, wherein said tool provides criteria for selection of credits to be given to another user, in the future.

29. A method as in claim 28, wherein said tool selects a future fixed time on which said code for said credits will be provided to said another user.

30. A method as in claim 28, wherein said tool selects a condition which must be met before said code for said credits will be provided to said another user.

31. A method, comprising:
using a computer for producing a user interface that allows selection from among items for sale on a purchasing website, where said items for sale include items which can be used on another website in a virtual world, and where said items for sale are usable on said another website;
using said computer for detecting a selection of said items on said purchasing website and for detecting a payment on said purchasing website by the user for said items; and
responsive to said selection and payment for said items, producing information that allows displaying a code on said purchasing website, where said code is usable to obtain said items on said another website without providing the item itself on the purchasing website, and where the item represented by the code is for the another website.

32. A method as in claim 31, wherein said payment is payment in real currency.

33. A method as in claim 31, wherein said item is usable on the another website, but is not available for purchase on the another website.

34. A method as in claim 31, wherein said displaying a code comprises providing the user with options of a number of different ways to memorialize the code.

35. A method as in claim 34, wherein said displaying a code comprises providing the code on a virtual gift card provided to the user.

36. A method as in claim 35, wherein said gift card includes a message in addition to the code.

37. A method as in claim 36, further comprising providing a template that allows the user to customize the gift card, including at least allowing the user to select a number of different occasions for the gift card, and to add another person's name on the gift card.

38. A method as in claim 31, further comprising using the code on said another website to obtain an item on the another website without payment by the user on the another website.

39. A method as in claim 38, further comprising providing a tool on the computer that controls a selection of a user to receive the code on the another website.

40. A method as in claim 39, wherein said tool provides criteria for selection of when said code will be provided to said user in the future.

41. A method as in claim 40, wherein said tool selects a future fixed time on which said code for said item will be provided to said user.

42. A method as in claim 40, wherein said tool selects a condition which must be met before said code for said item will be provided to said user.

43. A method, comprising:
on a first website, accepting registration of an item by entering a unique code that represents said item;
responsive to said accepting registration, showing an image of said item on said first website; and
using a purchased code purchased on a second website to obtain another item on the first website.

44. An apparatus, comprising:
a computer system that runs an E-store website that provides a code which corresponds to one of a selected item or a selected type of item for a reward for a person other than a current user accessing said E-store website, where said website provides said reward in a form that can be used by said other person without having that other person's account information, wherein said code is redeemable for one of the selected item or the selected type of item.

45. A method, comprising:
using a computer for producing a user interface that shows a number of credits, where the credits are units of virtual currency for use on the website, and where said credits are usable to obtain items on a website;
detecting a selection by a supervisory user of a number of credits to be allocated to multiple persons other than the supervisory user; and
using the computer for allocating said credits to said multiple persons other than the supervisory user without logging in as any of said multiple persons.

46. A method as in claim 45, wherein said selection comprises a selection of credits to be allocated in the future, and said allocating automatically occurs at a time subsequent to said selection.

47. A method as in claim 46, wherein said allocating occurs on a specified date.

48. A method as in claim 46, wherein said allocating occurs at specified periods.

49. A method as in claim 46, wherein said allocating occurs when a specified event occurs.

50. A method as in claim 46, wherein said specified event is an action that is confirmed by an external detection.

51. A method as in claim 46, wherein said allocating comprises providing a code indicative of said credits.

52. A method as in claim 45, further comprising obtaining a deluxe membership that provides additional capabilities on said website, and where said deluxe membership periodically allocates an additional number of said credits.

53. A method as in claim 45, wherein said other website includes at least one activity that can only be done a limited number of times per period.

54. A method as in claim 53, wherein said deluxe membership also increases a number of times that said at least one activity can be done.

55. A method as in claim 45, wherein said user interface provides a control for said supervisory user to reallocate credits among said multiple persons.
